(19) United States
(12) Patent Application Publication
(10) Pub. No.: US 2018/0121755 A1
(43) Pub. Date: May 3, 2018

(54) METHOD AND APPARATUS FOR RECOGNIZING OBJECT USING MULTI-SENSING

(71) Applicant: SAMSUNG SDS CO., LTD., Seoul (KR)

(72) Inventors: Yong Keun YUN, Seoul (KR); Kwang Jin KIM, Seoul (KR); Seung Ho SHIN, Seoul (KR)

(73) Assignee: SAMSUNG SDS CO., LTD., Seoul (KR)

(21) Appl. No.: 15/791,912

(22) Filed: Oct. 24, 2017

(30) Foreign Application Priority Data
Oct. 28, 2016 (KR) 10-2016-0141911

(51) Int. Cl. G06K 9/62; G06K 9/20; G06K 9/78; G06F 17/30

(52) U.S. Cl. CPC G06K 9/6202; G06K 9/623; G06K 2209/21; G06K 9/78; G06F 17/3079; G06K 9/2054

(57) ABSTRACT

A method for recognizing an object, including acquiring a device identifier (ID) assigned to a device carried by the object, through an object recognition apparatus, using the object recognition apparatus, filtering a plurality of object data using the acquired device ID to provide filtered object data, generating image data of the object from a video generated by a video sensor, comparing the image data of the object with the filtered object data, and recognizing the object based on a result of the comparison.

This application claims priority from Korean Patent Application No. 10-2016-0141911 filed on Oct. 28, 2016 in the Korean Intellectual Property Office, the disclosure of which is incorporated herein by reference in its entirety.

### BACKGROUND OF THE INVENTION

### 1. Field of the Invention

The present invention relates to a method and an apparatus for recognizing an object using multi-sensing. More particularly, the present invention relates to a method for primarily filtering an object to be recognized, using a wireless device sensor, and secondarily filtering the filtered result with a video sensor to minimize an amount of computation and an amount of collected data required for object recognition, and an apparatus to which the method is applied.

### 2. Description of the Related Art

Various methods are utilized as a method for recognizing an object existing in a monitoring zone. As an example thereof, there is a video-based object recognition technique for recognizing an object, by capturing an image of a specific region using an optical device such as a camera and by analyzing the captured result.

Since the conventional video-based object recognition method has depended on video analysis, when a new object was recognized, the object recognition apparatus has been required to compare the entire database with a new object to recognize the object. According to the conventional video-based object recognition method, since computations based on the entire database is executed each time, devices having high computing power have been required. Therefore, the conventional object recognition apparatuses have tried to solve the above problems, by including a separate server to configure a system or by installing a high-performance computing device in the area of interest.

Therefore, a new method is required to complement the conventional video-based object recognition method and to provide accurate object recognition performance, using a small device.

### SUMMARY OF THE INVENTION

An aspect of the present invention provides a method for supplementing the video-based object recognition method using the wireless device sensor, and an apparatus for executing the method. Thus, the object recognition apparatus can effectively recognize the object, while utilizing a small device.

Another aspect of the present invention provides an apparatus for recognizing an object, by primarily filtering an object such as a person, using a radio signal of a user terminal generally carried by the object such as the person, and by secondarily filtering the primarily filtered result using a video sensor, and an apparatus to which the method is applied. Thus, the object recognition apparatus can reduce the amount of computation, while maintaining the conventional recognition accuracy.

Still another aspect provides a method for creating a database for recognizing an object such as a person, using a radio signal of a user terminal generally carried by the object such as the person, and an apparatus to which the method is applied. Thus, the object recognition apparatus can efficiently manage the object database.

The aspects of the present invention is not limited to those mentioned above, and other aspects which have not been mentioned will be clearly understood from the description below to the ordinary technician in the technical field of the present invention.

According to aspect of the present invention provides a method for recognizing an object. The method comprises acquiring at least one or more device IDs assigned to a device carried by the object, through an object recognition apparatus, selecting an object data to be checked from a plurality of object data including video data of each object, using the acquired device ID, through the object recognition apparatus, querying the image data of the object recognized from the video generated by the video sensor in the object data to be checked to recognize the object.

The effects of the embodiment of the present invention are as follows.

When using the present invention as described above, unlike the existing object recognition apparatus having high computing power, the object recognition apparatus is made up of a small device and can effectively recognize the object.

When using the present invention as described above, since the object is recognized through two-stage filtering, there is an effect in which the entire amount of computation for recognizing the same object is greatly reduced.

When using the present invention as described above, since the recognized object is queried using the ID of the wireless device, there is an effect of being able to reduce the amount of line collection data for recognizing the same object, and more quickly to provide the recognized results.

The effects of the present invention are not limited to the aforementioned effects, and another effect not mentioned can be clearly understood by ordinary technicians from the following description.

### BRIEF DESCRIPTION OF THE DRAWINGS

The above and other aspects and features of the present invention will become more apparent by describing in detail exemplary embodiments thereof with reference to the attached drawings, in which:

FIG. 1 is a flowchart illustrating an object recognition method according to an embodiment of the present invention;

FIG. 2 is a flowchart for explaining a method by which an object recognition apparatus adds object data to a database in accordance with an embodiment of the present invention;

FIG. 3 is a diagram for explaining object data used in some embodiments of the present invention;

FIG. 4 is a flowchart for explaining an object recognition method according to an embodiment of the present invention in more detail;

FIG. 5 is a flowchart for explaining a method for recognizing the object by the object recognition apparatus, using a wireless device sensor;

FIG. 6 is a diagram for explaining a method for recognizing the object by the object recognition apparatus with reference to the detected Mac address;

FIG. 7 is a flowchart for explaining a method for recognizing the object by the object recognition apparatus, using a video sensor;

FIG. 8 is a block diagram for explaining an object recognition apparatus according to an embodiment of the present invention;

FIG. 9 is a hardware configuration diagram for explaining an object recognition apparatus according to an embodiment of the present invention; and

FIG. 10 is a hardware configuration diagram for explaining an object recognition apparatus according to another embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Since the conventional object recognition method based on the video recognition presents the aforementioned problems, the invention for solving the aforementioned problems of the related art is suggested through this specification.

The object recognition method according to the present embodiment may executed by an object recognition apparatus which includes a wireless device sensor and a video sensor. The object recognition apparatus primarily queries the ID of the user terminal carried by the object, using the wireless device sensor, secondarily analyzes the image of the object using the video sensor, and finally, object recognition apparatus may recognize the object. The object recognition apparatus may be a server that collects video data and wireless device information from a plurality of image capturing devices and device sensors, and may be an apparatus that is separately and directly installed in an area of interest for object recognition.

For convenience, the object recognition apparatus is expressed as including the wireless device sensor and the video sensor, but it is obvious that the object recognition apparatus does not need to necessarily include the wireless device sensor and the video sensor. It is a matter of course that the object recognition apparatus may receive data from an apparatus sensor and a video sensor separately provided devices and may analyze the data to recognize the object.

The video sensor refers to a CCTV or the like that captures an image of the object in the interest region, but various types of camera devices capable of collecting video information may be included in the video sensor. In the present invention, the video sensor captures the image of the interest region in real time to recognize the object.

In another embodiment of the present invention, the video sensor may be replaced by another kind of object recognition means. In other words, the object recognition means may include a glottis, a fingerprint, an iris, a signature recognition, and the like. The method for primarily filtering a recognition object using a wireless device and then utilizing the object recognition means as a secondary recognition means to lower the recognition computation amount of the object may be included in the embodiment of the present invention. In the present invention, as an example, a case where the secondary recognition means is an analysis of video data using the video sensor will be described as an example.

The user terminal preferably means a smart phone, and may include, but is not limited to, a cellular phone, a laptop computer, a digital broadcasting terminal, a PDA (personal digital assistants), a PMP (portable multimedia player), a slate PC, a tablet PC, an ultrabook, and a wearable device (e.g., a watch type terminal (smartwatch), a glass type terminal (smart glass), and a HMD (head mounted display)).

As mentioned above, the user terminal may be presented in various forms. However, the user terminal means an apparatus capable of performing radio frequency communication, using any one or more of a mobile communication network such as a code division multiple access (CDMA), a wide band code division multiple access (WCDMA), a high-speed packet access (HSPA) , and a long-term evolution (LTE), or a wired communication network such as Ethernet, a digital subscriber line (xDSL), a hybrid fiber coax (HFC), and an optical subscriber network (FTTH), or wireless local area network such as Bluetooth™, RFID (Radio Frequency Identification), Infrared Data Association (IrDA), UWB (Ultra Wideband), ZigBee, NFC (Near Field Communication), Wi-Fi (Wireless-Fidelity), Wi-Fi Direct, and Wireless USB (Universal Serial Bus). As the user terminal includes wired and radio communication means, the user terminal needs to be detected by the wireless device sensor. Since each object may not be specified with the normal AM/FM radio frequency, there is no corresponding matter.

It is desirable that the user terminal be an apparatus generally carried by each individual. Further, the user terminal needs to be selected as a device having a unique ID capable of being distinguished from other devices, such as a serial number of the device or a MAC address.

In this specification, in order to facilitate understanding, the description will be given of a case where the user terminal is a smartphone and the wired and radio communication network is Wi-Fi or Bluetooth, as an example. Further, the description will be given of a case where the recognition object of the object recognition apparatus is a person who carries the user terminal, as an example. In the embodiment of the present invention, it is assumed that everyone carries a user terminal having an ID capable of specifying a user terminal, such as a smartphone or a beacon.

With the development of IT device, since most people generally carry wireless devices such as all smart phones, the aforementioned assumptions will not be a problem.

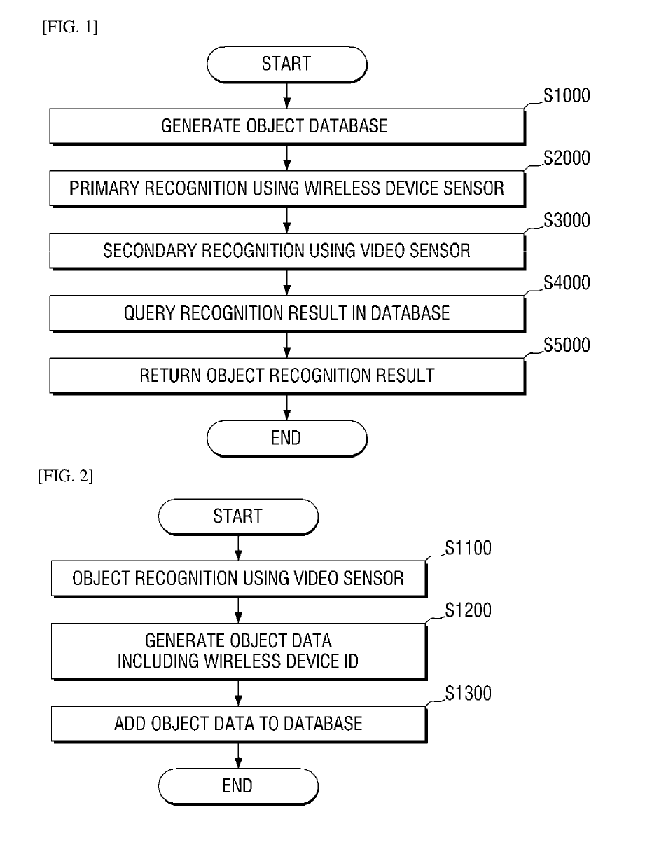

FIG. 1 is a flowchart illustrating an object recognition method according to an embodiment of the present invention.

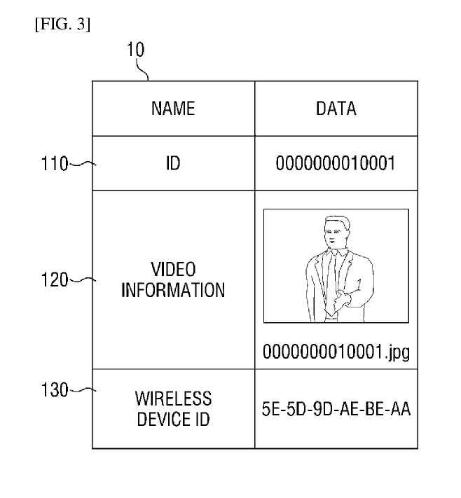

The method for recognizing an object according to the present invention begins when an object to be recognized enters an interest zone. Prior to the recognition of the new object, the object recognition apparatus may create a database to be used for recognizing the object (S1000). The object recognition apparatus may add the object to the database, by assigning the object ID, the image data, and the device ID to the new object. The method for adding a new object to the database by the object recognition apparatus will be described in more detail with reference to FIGS. 2 to 3.

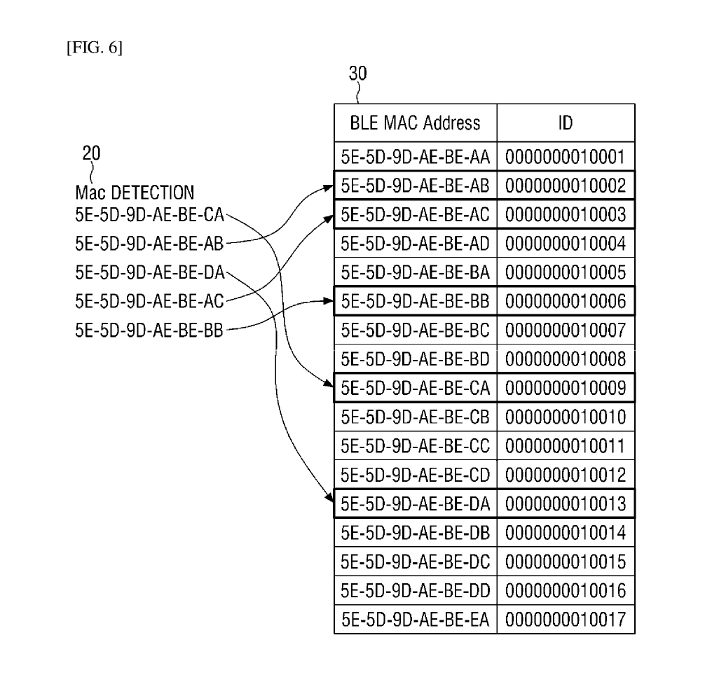

After creating the object database, when the same new object enters the interest zone, the object recognition apparatus primarily recognizes the new object, using the wireless device sensor (S2000). The object recognition apparatus queries the device ID of the object extracted via the wireless device sensor from the database and performs the primary filtering. A method for recognizing the primary object using a wireless device sensor will be described in more detail with reference to FIGS. 5 to 6.

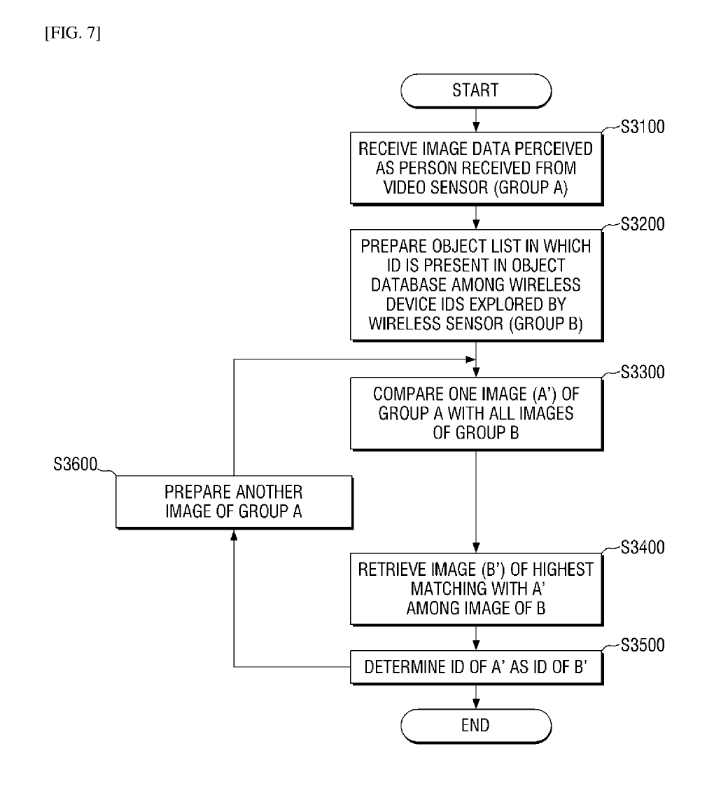

Thereafter, the object recognition apparatus receives the image data through the video sensor, and secondarily recognizes the object using the image data (S3000). The object recognition apparatus analyzes the image data of the object, and queries the analysis result in the primary filtering result. A method of recognizing the secondary object using the video sensor will be described in more detail with reference to FIG. 7.

The object recognition apparatus queries the object ID of the new object corresponding to the primary and secondary recognition results in the database (S4000), and finally may provide the user recognition result to the user (S5000).

FIG. 2 is a flowchart for explaining a method for adding the object data to a database by an object recognition apparatus according to an embodiment of the present invention, and FIG. 3 is a diagram for explaining the object data used in some embodiments of the present invention.

With reference to FIG. 2, a method for constructing a database by the object recognition apparatus will be described. The database construction means an action in which an administrator newly adds information on the object to be recognized to the object recognition apparatus.

Referring to FIG. 2, the object recognition apparatus recognizes a new object and starts adding database, using the video sensor (S1100). As described above, the object recognition apparatus may obtain the video data by independently providing the video sensor or may receive the provision of the video data from another image capturing device. Hereinafter, for convenience of explanation, the description will be given of a case where the object recognition apparatus receives data from another video sensor and the wireless device sensor. However, the present invention is not limited to such embodiments.

The object recognition apparatus extracts features of an object estimated as a person from the video data provided from the video sensor. The object recognition apparatus may recognize an object determined as a person from an image, by utilizing a general object recognition technique.

After specifying the object assumed to be a person, the object recognition apparatus extracts image data for converting the object into a database. The object recognition apparatus may generate an object data by collecting the object ID, the image data, and the device ID for recognizing the object (S1200), and adds the object data to the object database (S1300).

When the new object enters the interest region, the object recognition apparatus may be wirelessly connected to the new object to query the device ID of the object. In this case, the object recognition apparatus arbitrarily sets the object recognition ID, and may generate the object data, using the input image data and the extracted device ID.

Apart from this, the administrator of the object recognition apparatus may, of course, directly input the image data and the device ID to the object recognition apparatus to generate the object data and add the database.

Referring to FIG. 3, the object data 10 of a single object may include an object ID 110, video information 120 according to the image data, and a device ID 130.

The object ID 110 means a unique value used for distinguishing an input object from other objects. FIG. 3 illustrates (000000010001) as an example of the object ID. An object ID in the form of number is merely an example. Of course, in order to distinguish the new object from the object existing in the existing database, the object recognition apparatus may select the object ID, using various methods.

The video information 120 according to the image data may include various forms of data used by the object recognition apparatus for video analysis. In FIG. 3, an image obtained by capturing an image of the object is illustrated an example. Besides, the video information 120 may include specific data, pattern data and the like for video analysis.

The device ID 130 means an ID used for specifying the user terminal carried by the object. As an example of the device ID, a Mac address “5E 5D 9D AE BE AA” is illustrated. As an example of the MAC address, various forms of ID that may be used for specifying a user terminal, such as Mac address, serial number, and fixed IP address, may be used.

The object data information illustrated in FIG. 3 is an example, and the present invention is not limited thereto. In addition to the information illustrated, various types of information related to the object itself may be included.

For example, in the case of a person, the object ID may include profile information such as the name, age, and job title of the object, and may also include personnel information such as work hours, and department information. In this way, the object data may include information to be finally obtained by the administrator through the object recognition.

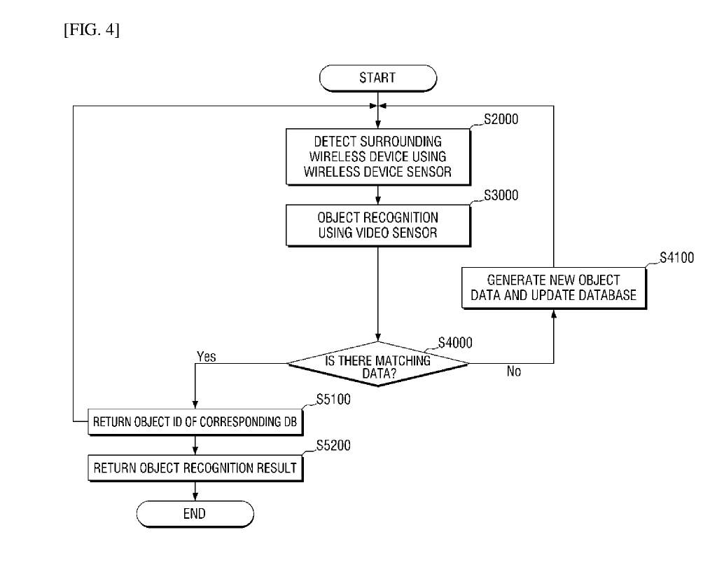

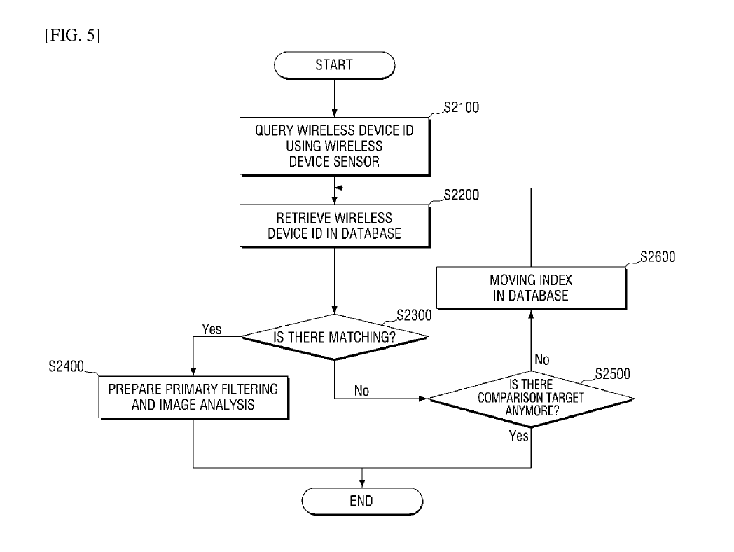

FIG. 4 is a flowchart for explaining the object recognition method according to an embodiment of the present invention in more detail.

The object recognition apparatus may recognize objects newly entering the interest region, by utilizing the object database constructed according to the above-described method. Referring to FIG. 4, a method of recognizing an object according to an exemplary embodiment of the present invention begins, while detecting a peripheral wireless device using a wireless device sensor (S2000). The wireless device sensor means a sensor which is connected to the wired and radio communication network to detect entry of the user terminal into the interest region.

For example, the wireless device sensor may be a device that senses whether there is a Wi-Fi connection of the user terminal. When it is determined that the object has entered the interest region, the wireless device sensor may be connected through the wireless communication network of the user terminal carried by the object to extract the device ID. The wireless device sensor may query the device ID of the user terminal by being connected to the user terminal, for example, via Wi-Fi. The device ID queried by the wireless device sensor is utilized to primarily filter the object from the database.

FIG. 5 is a flowchart for explaining a method for recognizing an object using an object recognition apparatus, using a wireless device sensor, and FIG. 6 is a diagram for explaining a method for recognizing the object by the object recognition apparatus, with reference to the detected Mac address and the database.

With reference to FIG. 5, a method for recognizing an object of a wireless device sensor will be described in more detail. Referring to FIG. 5, the primary object recognition of the wireless device sensor begins with the wireless device sensor querying the wireless device of the user terminal carried by the object (S2100). As described above, the wireless device sensor may be wirelessly connected to the user terminal via the wireless LAN to query the device ID.

After that, the object recognition apparatus retrieves the device ID from the object database (S2200). The object recognition apparatus determines whether or not there is an ID matching the device ID in the database (S2300). When an apparatus matching the retrieved device ID as the retrieve result is found in the database (S2400), the object recognition apparatus primarily filters the object data and may prepare a secondary filter using the image sensor (S2400).

More specifically, the object recognition apparatus determines whether or not the arbitrary object data included in the object database matches the device ID (S2400). If the device ID of the object data does not match the device ID of the current object as a result of the determination, the object recognition apparatus determines whether there is object data to be retrieved further on the database (S2500).

As a result of the determination, if there is an object to be further compared, the object recognition apparatus moves the index in the database (S2600) and compares the object data located at the other address with the object. The above steps are repeated until the object recognition apparatus finds the object data matching the device ID of the current object, and if the object data to be further compared exists no longer, the object recognition apparatus defines the object as a new object, or terminate the computation. In this case, the administrator may generate object data of the new object, add it to the database, or ignore the new object.

FIG. 5 illustrates an aspect in which the object recognition apparatus queries the device ID 20 queried in the interest region from the database 30. The object recognition apparatus may simultaneously query a plurality of device IDs. The database illustrated in FIG. 5 illustrates only the Mac address and the object ID. In this way, since only the device ID is used for the primary filter, it is desirable that the image data be ignored in the primary filter processing.

Referring to the example illustrated in FIG. 5, the object recognition apparatus may know that a total of five objects are recognized in the interest region. It is possible to check that a total of 5 MAC addresses prepares for filtering.

The object recognition apparatus retrieves the queried MAC address 20 from the database 30. The primary filtering of the object recognition apparatus of a plurality of objects may be performed at the same time. The aspect in which the object recognition apparatus detects a matching object ID is also illustrated together. Referring to the detection result, it is possible to know that (5E 5D 9D AE BE CA) matches the object ID (000000010009), (5E 5D 9D AE BE AB) matches the object ID (000000010002), (5E-5D-9D-AE-BE-DA) matches the object ID (000000010013), (5E 5D 9D AE BE AC) matches the object ID (000000010003), and (5E 5D 9D AE BE BB) matches the object ID (000000010006).

If there is an object that is not recognized by the wireless device sensor but is recognized only by the image sensor, the object recognition apparatus may refer to the object information of the other recognized object, and may recognize the object recognized only by the video sensor.

For example, assuming a case where a total of 10 persons are perceived by the video sensor in the interest region, but only the five user terminals are detected. In this case, five persons carrying the user terminal can quickly recognize the object in accordance with the present invention. However, in the case of the five persons who do not carry the wireless device, since the object recognition is performed in accordance with the conventional method, there is a problem of an increase in amount of computation.

In such a situation, the object recognition apparatus may recognize the object on which the user terminal is not detected, by referring to the object information of the already recognized object. In the above example, there is a high possibility that five persons who do not carry the user terminal may be related to five persons who carry the user terminal. In this case, it is desirable that the object recognition apparatus first reviews the object data having relatively high correlation to recognize the object, through the correlation comparison of the object attribute information included in the object data. According to the embodiment, it is possible to provide quick object recognition to an object that does not carry a user terminal.

In the above example, there is a high probability that the five persons who do not carry the user terminal are persons having friendships with the five persons who carry a user terminal or who are working in the same department. It is possible to more quickly recognize the object on the basis of the object information.

Returning to FIG. 4 again, the object recognition method will be further explained. As a detection result of the wireless device using the wireless device sensor, the object database is primarily filtered. If there is matching object data, the object recognition apparatus performs the secondary object recognition and filtering using the video sensor (S3000).

The object recognition apparatus may analyze the image collected through the video sensor. The object recognition apparatus may compare the video data with the image data of the object database to perform the secondary object recognition. The secondary object recognition method will be described in more detail with reference to FIG. 7.

The object recognition apparatus may determine whether the object data of an object entering the interest region exists in the object database in accordance with the results of the two-step object recognition of the wireless device sensor and the video sensor (S4000). As a result of the determination, if there is no matching object data, since this means that an object not included in the database is input, the object recognition apparatus generates a new object data by utilizing the device ID and the image data acquired in the process of recognizing the object, and may add the new object data to the database (S4100).

When there is object data matching the object data of the object that is input to the object database as the result of the two-step object recognition, the object recognition apparatus returns the object ID of the corresponding database (S5100). The object recognition apparatus may provide the administrator with the object ID according to the object recognition result (S5200). The object recognition apparatus may directly provide the object ID to the administrator or may let the administrator know to whom the object accurately points, by referring to the object attribute information attached to the queried object data. Of course, it is possible to provide additional information of the object data to the administrator.

FIG. 7 is a flowchart for explaining a method for recognizing an object by the object recognition apparatus, using the video sensor.

Referring to FIG. 7, the object recognition method starts to receive the image of the image from the video sensor by the object recognition apparatus, when an object recognized as a person is captured on the image, while capturing the image of the interest region by a video sensor. Since a plurality of objects may exist inside the interest region, the video sensor may receive a plurality of images on the object recognition apparatus for a certain period of time. An image data group of an object perceived by the video sensor as a person is defined as a group A.

As described above, various techniques for detecting an object from a conventional image may be utilized as the method for detecting the object determined as a person by the video sensor. In the future, it is desirable to utilize an object detection technique that can clearly separate color and contrast for comparison of image data.

The object recognition apparatus prepares a list of objects having the possibility of being present in the current interest region through the device ID detected in the interest region, in accordance with the primary object recognition method described above (S3200). Referring to the example of FIGS. 6, (000000010002), (000000010003), (000000010006), (000000010009), and (000000010013) may be included therein. A group of the objects in which the device ID exists in the object database among the device IDs detected by the wireless device sensor is defined as a group B.

The object recognition apparatus selects any one of the image data belonging to the group A. At this time, one image selected by the object recognition apparatus is defined as A′. The object recognition apparatus compares the video data of A′ with the image data included in the object data of group B (S3400). As a method of comparing the image data, conventionally proposed various video analysis filters and algorithms may be utilized. The object recognition apparatus may make two or more algorithms overlap in parallel, and may transform or process the image data for comparison. Only certain parts of the image data may be compared when comparing, and the entire image data may be compared together with the background.

The object recognition apparatus may retrieve B′ which is an object including the image data with the highest probability of matching with A′ in the group B, (S3400). In other words, the object recognition apparatus secondarily filters the B′ object corresponding to A′, which is the recognition target object in the group B as a result of the primary filtering through the image data comparison.

When the object B′ is detected through the retrieval, the object recognition apparatus may determine that the ID of the object included in the image A′ is an object having the B′ object data (S3500). When the object recognition apparatus completes the recognition of any one of the images of the group A, the object recognition apparatus repeats the above retrieval for other images constituting the group A.

The method has been described in which the object recognition apparatus recognizes the object finally entering the interest region, using the wireless device sensor and the video sensor. When an object carrying a user terminal that can be connected to a wireless communication network enters the interest region, the object recognition apparatus queries the device ID of the user terminal, using the wireless device sensor. The object recognition apparatus retrieves the queried device ID from the object database and extracts the object data corresponding to the device ID. The object recognition apparatus primarily filters the object database, using the wireless device sensor.

The object recognition apparatus receives an image of an object that has entered the interest region, compares the image data of the object with the image data of the primarily filtered object database, and finally determines the object that has entered the interest region. The object recognition apparatus secondarily filters the object database, which is primarily filtered using the wireless device sensor, using the video sensor.

As presented in the conventional problem, in the object recognition method through the video analysis, it is necessary to perform the image object recognition and the video analysis on all objects entering the interest region. Furthermore, since it is necessary to analyze the above object recognition result again and determine whether or not there is an object with matching image on all the databases, a very high computation amount is required as compared with the function to be executed. On the other hand, simply querying the device ID in the database is a simple data comparison computation, the amount of computation is smaller than in the video analysis.

According to the embodiment of the present invention, the object recognition apparatus may reduce the amount of computation required by the existing object recognition method, by using the device ID detection requiring the low computation amount as the primary filtering element, and by using the video analysis requiring more computation amount as the secondary filtering element.

Further, video analysis is performed on the basis of probability, while the device ID comparison is directly determined as to whether IDs are identical or not. When the object recognition function by the video analysis is supplemented by the device ID comparison, the accuracy can be greatly improved.

The methods according to the embodiment of the present invention described above can be executed by execution of a computer program implemented as computer-readable code. The computer program may be transferred to a second computing device from a first computing device via a network such as Internet and may be installed on the second computing device, and may be used in the second computing device, accordingly. The first computing device and the second computing device include all of a server device, a physical server belonging to a server pool for a cloud service, a fixed computing device such as a desktop PC or the like.

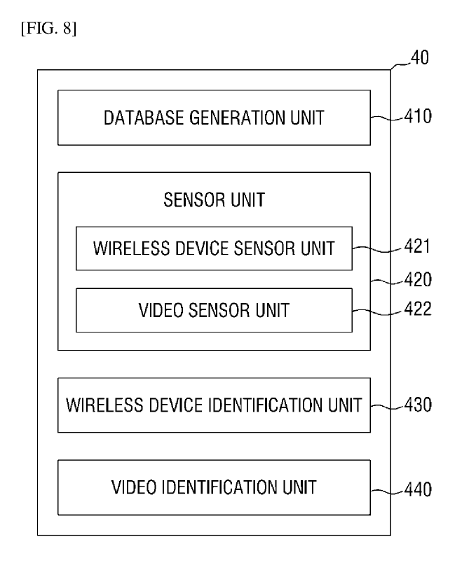

FIG. 8 is a block diagram for explaining an object recognition apparatus 40 according to an embodiment of the present invention.

Referring to FIG. 8, the object recognition apparatus 40 may include a database generation unit 410, a sensor unit 420, an device ID recognition unit 430, and a video recognition unit 440. Since the operation of each component is the same as that described in the method for providing traffic information, it will be roughly described here.

The database generation unit 410 may generate an object database used for recognizing the object. In the object database, the object ID, the image data, and the device ID of a new object are added to generate the object data, and the object data may be added to the database. The database generation unit 410 may directly receive the provision of the object ID, the video data, and the device ID from the administrator for adding the database, the object recognition apparatus 40 may autonomously include the database generation unit 410, or the database generation unit 410 may receive the provision of the image data and the device ID from the wireless device sensor and the video sensor which receives the data.

The sensor unit 420 may include various sensors for collecting the image data and the device ID for recognizing the object. The sensor unit 420 may include a wireless device sensor unit 421, and a video sensor unit 422. As described above, the secondary object recognition method of the present invention is not limited to the object recognition of the video analysis. As described above, the video sensor is an example for the secondary recognition.

The wireless device sensor unit 421 may extract the device ID of the user terminal carried by the object entering the interest region from the wireless device sensor autonomously included in the object recognition apparatus 40, or may receive the device ID from the wireless device sensor which is configured separately from the object recognition apparatus 40.

The video sensor unit 422 may extract the video data of an object entering an interest region from the video sensor included in the object recognition apparatus 40 or may receive the image data for image recognition of the object from the wireless device sensor provided separately from the object recognition apparatus 40.

In addition to the above-described sensors, the object recognition apparatus may also extract recognition information of the object entering the interest region from various forms of sensors provided autonomously, or may receive recognition information for recognition of the object from the sensor separately provided. Both the image data and the recognition information may be utilized for a secondary recognition method of the objects.

The device ID recognition unit 430 primarily recognizes the object that entered the interest region with reference to the device ID received by the wireless device sensor unit 421. The device ID recognition unit 430 may query the device ID, using the MAC address, the serial number or the like of the user terminal carried by the object.

The image recognition unit 440 determines what the object entered the interest region, by referring to the database primarily filtered from the device ID recognition unit 430. The video recognition unit 430 refers to the image data from the filtering result provided by the device ID recognition unit 430, compares the image data with the video data received from the video sensor unit 422 to secondarily recognize the object.

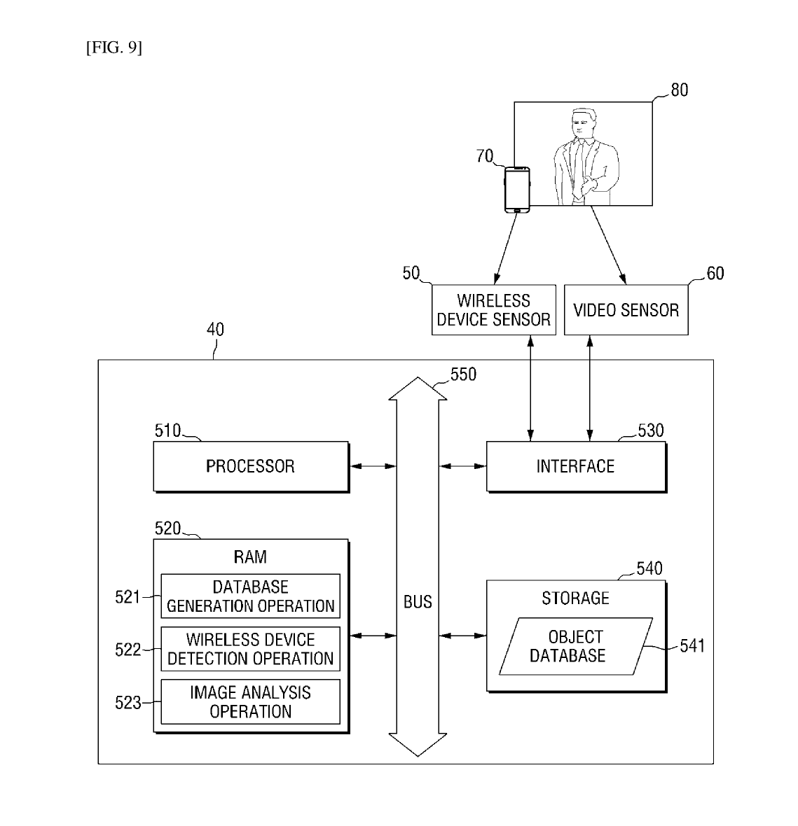

FIG. 9 is a hardware configuration diagram for explaining an object recognition apparatus 40 according to an embodiment of the present invention.

Referring to FIG. 9, a traffic information providing device 20 may include one or more processors 510, a memory 520, a sensor 530, a storage 540 and a data bus 550.

An object recognition operation implemented to execute the object recognition method may reside in the memory 520.

The memory 520 may include a database generation operation 521, a wireless device detection operation 522, and an image analysis operation 523. Since the detailed action of the operation in the memory 520 are the same as the method for executing each step described in the object recognition method, it will be roughly described here.

The interface 530 may include a network interface for transmitting and receiving information between the wireless device sensor 50 and the video sensor 60. The wireless device sensor 50 extracts the device ID of the user terminal 70 carried by the object 80 to be recognized, and the video sensor 60 may receive the image data of the object.

The interface 530 may transmit and receive data with the wireless device sensor 50 or the video sensor 60 in the system, using one or more of be a mobile communication system such as code division multiple access (CDMA), wide band code division multiple access (WCDMA), high-speed packet access (HSPA), and long term evolution (LTE), or a wired communication network such as Ethernet, a digital subscriber line (xDSL), hybrid fiber coax (HFC), and an optical subscriber network (FTTH), or a wireless local area network such as Wi-Fi, Wibro or WiMAX.

Further, it is a matter of course that the interface 530 may be connected to the wireless device 50 and the video sensor 60 in a wired manner to transmit and receive data.

A program (not illustrated) implemented to execute the method of providing the traffic information may be stored in the storage 540, and an application programming interface (API), a library file, a resource file, and the like may be stored in the storage 540. Further, the storage 540 may store an object database 541 and the like utilized for the object recognition method.

The data bus 550 is a moving path for transferring data among the respective constituent elements such as the processor 510, the memory 520, the interface 530 and the storage 540.

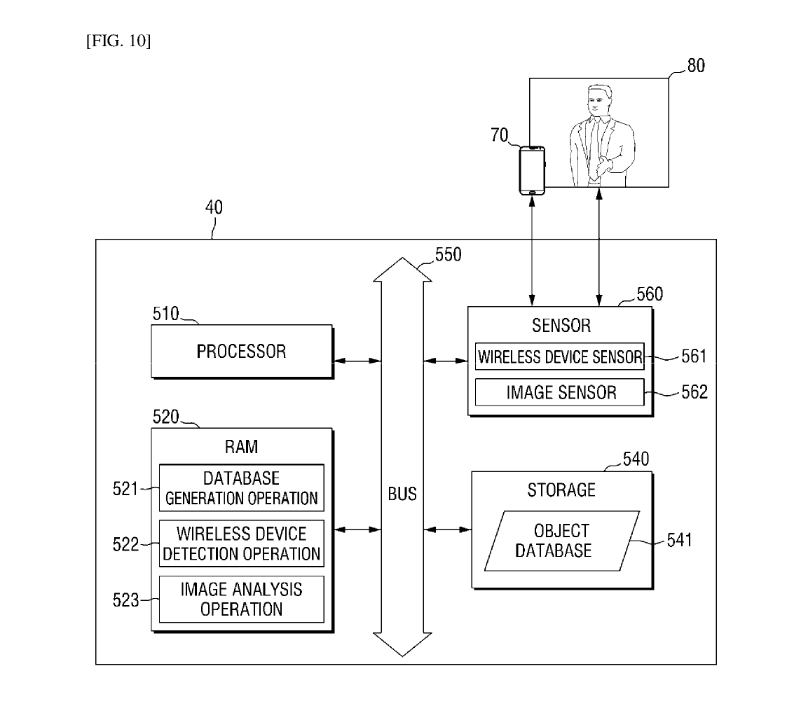

FIG. 10 is a hardware configuration diagram for explaining an object recognition apparatus 40 according to another embodiment of the present invention.

Referring to FIG. 10, the object recognition apparatus 40 according to another embodiment of the present invention may instead include its own sensor 560. The sensor 560 may include a wireless device sensor 561 and an image sensor 562. According to the object recognition apparatus 40 illustrated in FIG. 10, the object recognition apparatus 40 may recognize the object, using the sensor 560 provided autonomously. The wireless device sensor 561 may extract the device ID of the user terminal 70 carried by the object 80 to be recognized, and the video sensor 60 may receive the image data of the object.

Each of the components of FIG. 9 and FIG. 10 may mean software or hardware such as FPGA (Field Programmable Gate Array) or ASIC (Application-Specific Integrated Circuit). However, the above-described components are not limited to software or hardware, but may be configured to be located in a storage medium capable of addressing, and may be configured to execute one or more processors. The functions provided in the above-mentioned components may be implemented by further segmented constituent elements, and a plurality of constituent elements maybe combined and provided as a single constituent element that performs a specific function.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method for recognizing an object, the method comprising:
acquiring a device identifier (ID) assigned to a device carried by the object, through an object recognition apparatus;
using the object recognition apparatus, filtering a plurality of object data using the acquired device ID to provide filtered object data;
generating image data of the object from a video generated by a video sensor;
comparing the image data of the object with the filtered object data; and
recognizing the object based on a result of the comparison.

2. The method of claim 1, wherein the image data comprises:
data corresponding to an image which includes the object; and
the device ID assigned to the device carried by the object.

3. The method of claim 1, wherein the recognizing of the object comprises:
adding object data corresponding to the object to an object database, when the filtered object data does not match the acquired device ID or the image data.

4. The method of claim 1, further comprising:
determining whether the object enters an interest region randomly selected in the video generated by the video sensor through the object recognition apparatus,
wherein acquisition of the device ID, filtering of the object data , and recognizing of the object are performed when the object recognition apparatus determines that the object enters the interest region.

5. The method of claim 4, wherein determining of whether the object enters the interest region comprises:
determining whether the object enters the interest region based on whether the object is observed using the video sensor.

6. The method of claim 4, wherein the determining of whether the object enters the interest region comprises:
determining that the object enters the interest region based on whether the acquired device ID is in an object database.

7. The method of claim 1, wherein the recognizing of the object comprises recognizing the object within a specified time limit, wherein the specified time limit is a time which is shorter than a time required for data access to all of the object data in an object database, and is longer than a time required for data access to all of the filtered object data.

8. The method of claim 1, wherein the recognizing of the object comprises:
recognizing the object perceived by the video sensor with reference to object information of an other recognized object, when the device ID is not acquired but the object is perceived by the video sensor.
